(19) United States
(12) Patent Application Publication
(10) Pub. No.: US 2025/0209914 A1
(43) Pub. Date: Jun. 26, 2025

(54) INFORMATION NOTIFICATION DEVICE

(71) Applicant: TOYOTA JIDOSHA KABUSHIKI KAISHA, Toyota-shi (JP)

(72) Inventor: Hiroaki ITO, Nisshin-shi (JP)

(73) Assignee: TOYOTA JIDOSHA KABUSHIKI KAISHA, Toyota-shi (JP)

(21) Appl. No.: 18/791,662

(22) Filed: Aug. 1, 2024

(30) Foreign Application Priority Data
Dec. 21, 2023 (JP) 2023-215754

(51) Int. Cl. G08G 1/0962; G06V 20/58; G08G 1/01

(52) U.S. Cl. CPC G08G 1/09623; G06V 20/582; G08G 1/0133; G08G 1/09626

(57) ABSTRACT

When the traffic sign is not recognized from the image information, a traffic rule output to the display device is generated based on the travel road sign included in the map information and indicating the traffic sign provided on the traveling road of the vehicle. When the traffic sign is recognized from the image information, the traffic rule is generated based on the image-recognized sign indicating the traffic sign included in the image information. Based on the image-recognized sign, it is determined whether the travel road sign is correct. When it is determined that the travel road sign is an error, the distance or time for continuing outputting the traffic rule to the display device is extended as compared with the case where it is determined that the travel road sign is correct.

### CROSS-REFERENCE TO RELATED APPLICATION

This application claims priority to Japanese Patent Application No. 2023-215754 filed on Dec. 21, 2023, incorporated herein by reference in its entirety.

### BACKGROUND

### 1. Technical Field

The present disclosure relates to devices that notify a user of a vehicle of a traffic rule for a road (travel road) on which the vehicle travels.

### 2. Description of Related Art

Japanese Unexamined Patent Application Publication No. 2022-096906 (JP 2022-096906 A) discloses a driver assistance system. This conventional system checks a road sign recognized from image information acquired by capturing an image of a travel road of a vehicle against a road sign provided from a driver assistance device, and outputs the result of checking these road signs against each other to a display device. When these two road signs do not match, the road sign recognized from the image information is output as the checking result. When these two road signs match, the matching road sign is output as the checking result.

### SUMMARY

In the above conventional system, it is not specified whether the road sign that is output to the display device when the two road signs match is the road sign recognized from the image information or the road sign provided from the driver assistance device. The former case will be considered. In this case, the road sign recognized from the image information is output to the display device as the checking result, regardless of whether the two road signs match. Therefore, when the road sign recognized from the image information is correct, the driver of the vehicle can be notified of a correct traffic rule for the travel road of the vehicle.

However, in the above conventional system, there is no mention of how long the road sign recognized from the image information continues to be output to the display device. Therefore, if the road sign recognized from the image information continues to be output to the display device for a short period of time, the road sign provided from the driver assistance device may be output from the display device once this period ends. In this case, if the road sign recognized from the image information is correct, the driver of the vehicle may be notified of a wrong traffic rule for the travel road of the vehicle, which may confuse the driver of the vehicle.

One object of the present disclosure is to provide an information notification device that reduces occurrence of a situation in which a user of a vehicle is notified of a wrong traffic rule for a travel road of the vehicle.

The present disclosure is a device that notifies a user of a vehicle of a traffic rule for a travel road of the vehicle. The device has the following features.

The device includes a camera, a storage device, and a processor. The camera is mounted on the vehicle. The camera is configured to acquire image information around the travel road. The storage device stores map information including traffic signs installed on roads. The processor is configured to output the traffic rule to a display device.

The processor is configured to
when no traffic sign is recognized from the image information, generate the traffic rule based on a travel road sign that indicates the traffic sign included in the map information and installed on the travel road, and
when any traffic sign is recognized from the image information, generate the traffic rule based on an image-recognized sign that indicates the traffic sign recognized from the image information.

The processor is further configured to
when any traffic sign is recognized from the image information, determine based on the image-recognized sign whether the travel road sign is correct, set a distance or time for which the traffic rule generated based on the image-recognized sign continues to be output to the display device, and
when the travel road sign is determined to be wrong, extend the distance or time for which the traffic rule continues to be output to the display device as compared to when the travel road sign is determined to be correct.

According to the present disclosure, when any traffic sign is recognized from the image information, whether the travel road sign is correct is determined based on the image-recognized sign. When the travel road sign is determined to be wrong, the distance or time for which the traffic rule continues to be output to the display device is extended as compared to when the travel road sign is determined to be correct. That is, when the travel road sign is determined to be wrong, the traffic rule generated based on the image-recognized sign is output to the display device for a longer distance or a longer time. This can reduce occurrence of a situation where the user of the vehicle is notified of a wrong traffic rule for a travel road, as compared to the case where the distance or time for which the traffic rule continues to be output to the display device is the same between when the travel road sign is determined to be wrong and when the travel road sign is determined to be correct.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating a configuration example of an information notification device according to an embodiment;

FIG. 2 is a block diagram illustrating an example of a functional configuration of the information processing device illustrated in FIG. 1;

FIG. 3 is a diagram illustrating a distance or time for continuing to display traffic rules;

FIG. 4 is a flow chart illustrating an exemplary process particularly related to an embodiment; and

FIG. 5 is a flowchart illustrating an example process particularly related to an embodiment.

### DETAILED DESCRIPTION OF EMBODIMENTS

Hereinafter, embodiments of the present disclosure will be described with reference to the drawings. However, the structures and the like described in the following embodiments are not necessarily essential to the present disclosure except for the case where they are particularly explicitly described or are clearly specified in principle.

### 1. Configuration Example of Information Notification Device

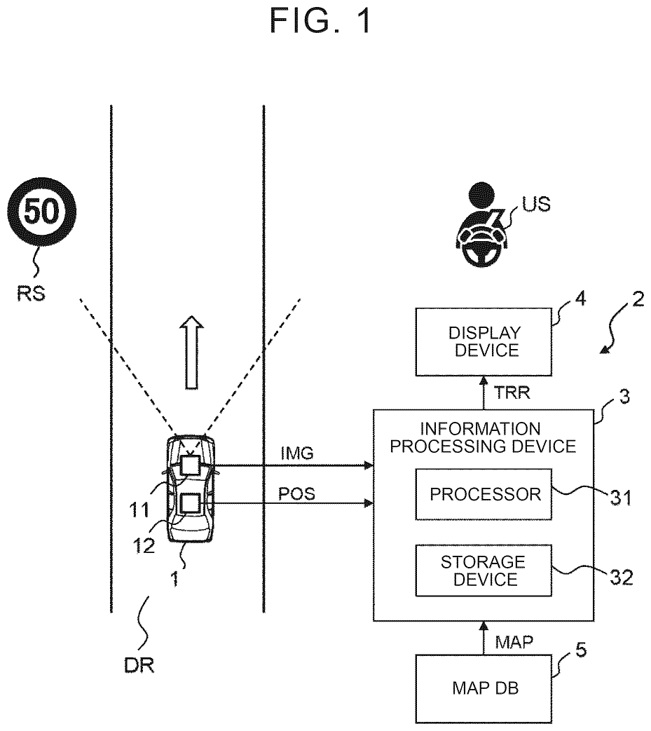

FIG. 1 is a conceptual diagram illustrating a configuration example of an information notification device according to an embodiment. The information notification device 2 notifies the user US of the vehicle 1 of information. The user US is, for example, an operator of the vehicle 1. The operator of the vehicle 1 may be a driver riding on the vehicle 1, or may be a remote operator that remotely operates (remote driving, remote support) the vehicle 1. The vehicle 1 may be a manual driving vehicle or an automatic driving vehicle. The information notification device 2 may be mounted on the vehicle 1 or may be included in a remote operator terminal operated by a remote operator. A part of the information notification device 2 may be included in the cloud server.

The information notification device 2 includes an information processing device 3, a display device 4, and a map DB (database) 5. The information processing device 3 includes at least one processor 31 and at least one storage device 32. The processor 31 executes various kinds of information processing. Examples of the processor 31 include a central processing unit (CPU), a graphics processing unit (GPU), application specific integrated circuits (ASICs), a field-programmable gate array (FPGA), and the like. The storage device 32 stores various types of information. Examples of the storage device 32 include volatile memory, non-volatile memory, a hard disk drive (HDD), a solid state drive (SSD), and the like.

The information processing device 3 acquires the image information IMG of the surroundings of the travel road DR of the vehicle 1 from the cameras 11 mounted on the vehicle 1. The information processing device 3 also recognizes the traffic sign RS included in the image information IMG by analyzing the image information IMG. When the traffic sign RS is recognized, the information processing device 3 outputs traffic rule TRR indicated by the recognized traffic sign RS (hereinafter, also referred to as “image-recognized sign IRS”) to the display device 4.

The information processing device 3 acquires position information POS indicating the position (latitude and longitude) of the vehicle 1 from a global navigation satellite system (GNSS) sensor 12 mounted on the vehicle 1. Based on the history of the position information POS and the map information MAP stored in the map DB 5, the information processing device 3 also outputs the traffic rule TRR indicated by the traffic sign RS (hereinafter, also referred to as “travel road sign DRS”) provided on the travel road DR to the display device 4.

The display device 4 displays the traffic rule TRR received from the information processing device 3. The display device 4 may be a display mounted on the vehicle 1 or a head-up display (HUD), or may be a display of a remote operator terminal. The traffic rule TRR is information about a traffic rule related to a travel road DR. Examples of the traffic rule TRR include images of traffic sign RS, icons of traffic sign RS, or content indicated by traffic sign RS. When the image-recognized sign IRS and the travel road sign DRS are obtained, the display device 4 preferentially displays the traffic rule TRR indicated by the image-recognized sign IRS. When only the travel road sign DRS is obtained, the display device 4 displays the traffic rule TRR indicated by the travel road sign DRS.

The map DB 5 is formed in a predetermined storage device (for example, a non-volatile recording medium such as a hard disk or a flash memory). The map DB 5 stores a map information MAP. The map information MAP includes a generic navigational map. Examples of the information included in the navigation map include information on a position of a road, information on a road shape (for example, a curve, a type of a straight line), information on an intersection, and information on a position of a structure. The construction includes a travel road sign DRS.

### 2. Functional Configuration Example of Information Processing Device

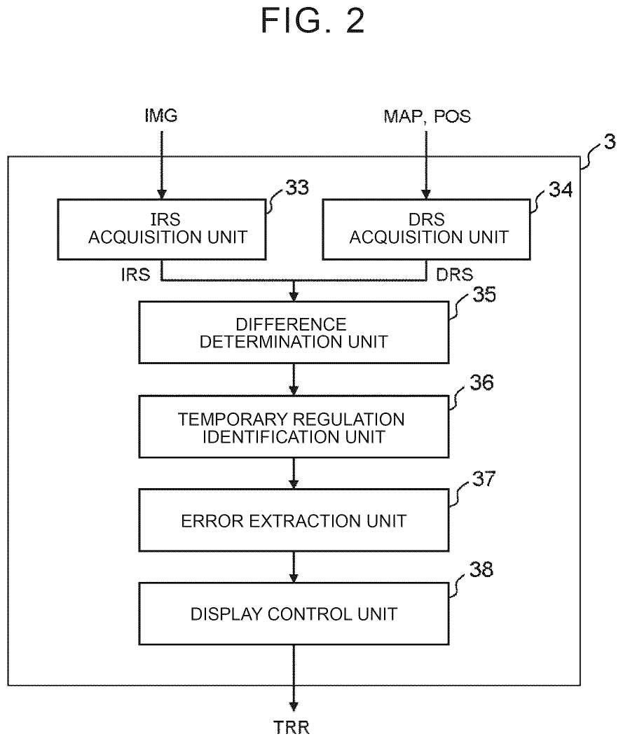

FIG. 2 is a block diagram illustrating a functional configuration example of the information processing device 3 illustrated in FIG. 1. In the embodiment illustrated in FIG. 2, the information processing device 3 includes a IRS acquiring unit 33, a DRS acquiring unit 34, a difference determination unit 35, a temporary restriction identification unit 36, an error extracting unit 37, and a display control unit 38. These functional blocks are realized by, for example, cooperation of the processor 31 and the storage device 32.

IRS acquiring unit 33 acquires the image-recognized sign IRS based on the image information IMG. IRS acquiring unit 33 recognizes the traffic sign RS from the image information IMG by using, for example, an image recognition artificial intelligence (AI). The image recognition AI is generated in advance through a learning method such as deep learning. The image recognition AI is learned so that various traffic sign RS can be detected from the image information IMG and the type of detected traffic sign RS can be specified. IRS acquiring unit 33 may read the speed limit designated by the recognized speed limit indicator by image-analysis. When the image-recognized sign IRS is acquired, IRS acquiring unit 33 outputs this to the difference determination unit 35.

The DRS acquiring unit 34 acquires the travel road sign DRS based on the position information POS and the map information MAP. For example, DRS acquiring unit 34 specifies the present position of the vehicle 1 and the travel road DR from the history of the position information POS. When the current position and the travel road DR are identified, DRS acquiring unit 34 refers to the map information MAP using the current position and the travel road DR to acquire the traffic sign RS (that is, the travel road sign DRS) provided on the travel road DR. When the travel road sign DRS is acquired, DRS acquiring unit 34 outputs this to the difference determination unit 35 and the display control unit 38.

The difference determination unit 35 determines whether there is a difference between the image-recognized sign IRS and the travel road sign DRS. The difference determination unit 35 calculates, for example, the similarity between the image-recognized sign IRS and the travel road sign DRS. When the similarity is less than the threshold value, it is determined that there is a difference between the image-recognized sign IRS and the travel road sign DRS. When it is determined that there is a difference, the difference determination unit 35 outputs the image-recognized sign IRS and the travel road sign DRS to the temporary restriction identification unit 36.

The temporary restriction identification unit 36 determines whether or not the image-recognized sign IRS corresponds to a temporary restriction sign. For example, the temporary restriction identification unit 36 determines whether or not the image-recognized sign IRS corresponds to an electro-optical sign by using the image recognition AI. When it is determined that the image-recognized sign IRS corresponds to the electro-optical sign, the temporary restriction identification unit 36 determines that the reason for the difference between the image-recognized sign IRS and the travel road sign DRS is due to the temporary restriction sign. If it is determined that this is not the case, the temporary restriction identification unit 36 outputs the image-recognized sign IRS and the travel road sign DRS to the error extracting unit 37.

When the image-recognized sign IRS and the travel road sign DRS are inputted, the error extracting unit 37 determines that there is an error in the travel road sign DRS. In this case, the information (for example, the road ID) of the road on which the travel road sign DRS determined to be erroneous is provided is recorded in the storage device 32 together with the cumulative number CN of the determination. When it is determined that there is an error, the error extracting unit 37 outputs the image-recognized sign IRS to the display control unit 38 together with the error detecting signal of the travel road sign DRS. When it is determined that there is no error, the error extracting unit 37 outputs the image-recognized sign IRS to the display control unit 38.

The display control unit 38 performs control (display control) for displaying the traffic rule TRR on the display device 4. As described above, the traffic rule TRR is information about the traffic rule related to the travel road DR. The image-recognized sign IRS, the travel road sign DRS, and the error-detection-signal can be inputted to the display control unit 38. When only the travel road sign DRS is inputted, the display control unit 38 displays the traffic rule TRR indicated by the travel road sign DRS on the display device 4. When the image-recognized sign IRS and the travel road sign DRS are inputted, the display control unit 38 displays the traffic rule TRR indicated by the image-recognized sign IRS on the display device 4. When an error detection signal is received, the display control unit 38 may display the traffic rule TRR indicated by the image-recognized sign IRS on the display device 4.

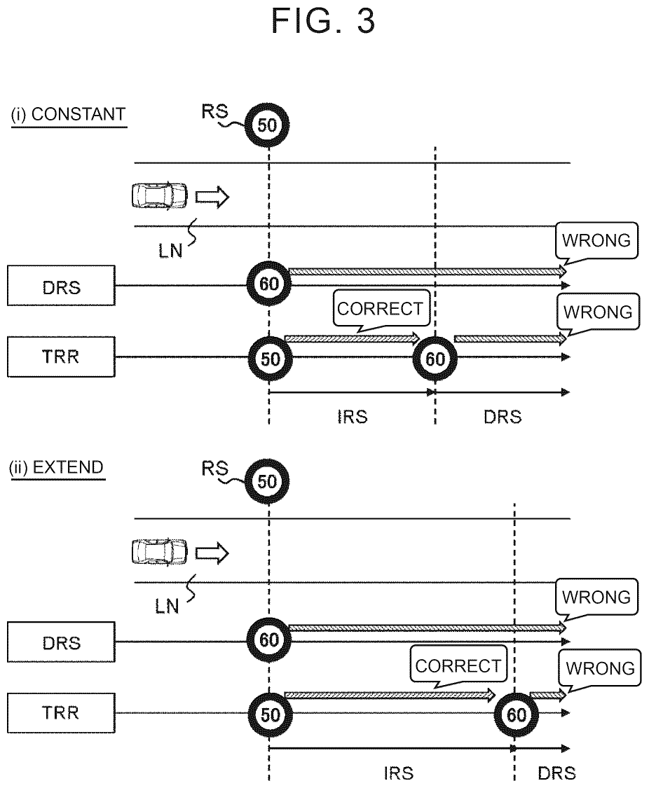

FIG. 3 is a diagram for explaining distances or times at which the traffic rule TRR is continuously displayed. In the upper part of FIG. 3, (i) is depicted when the distance or time is constant. In the lower part of FIG. 3, a ii is depicted where this length or duration is extended. In the cases (i) and (ii), it is determined that the image-recognized sign IRS (travel speed 50 km/s) is correct and that there is an error in the travel road sign DRS (travel speed 60 km/s).

In the case (i), in other words, when the distance or time for continuing to display the traffic rule TRR indicated by the image-recognized sign IRS is constant, when the display of the correct information (that is, the traffic rule TRR indicated by the image-recognized sign IRS) is completed, the display of the erroneous information (that is, the traffic rule TRR indicated by the travel road sign DRS) is started. Switching of the indication is also envisaged in ii. However, in cases (ii), the length or duration over which the correct information continues to be displayed is extended.

As described above, according to the embodiment, it is possible to suppress erroneous information from being notified to the user US.

### 3. Example of Information Processing

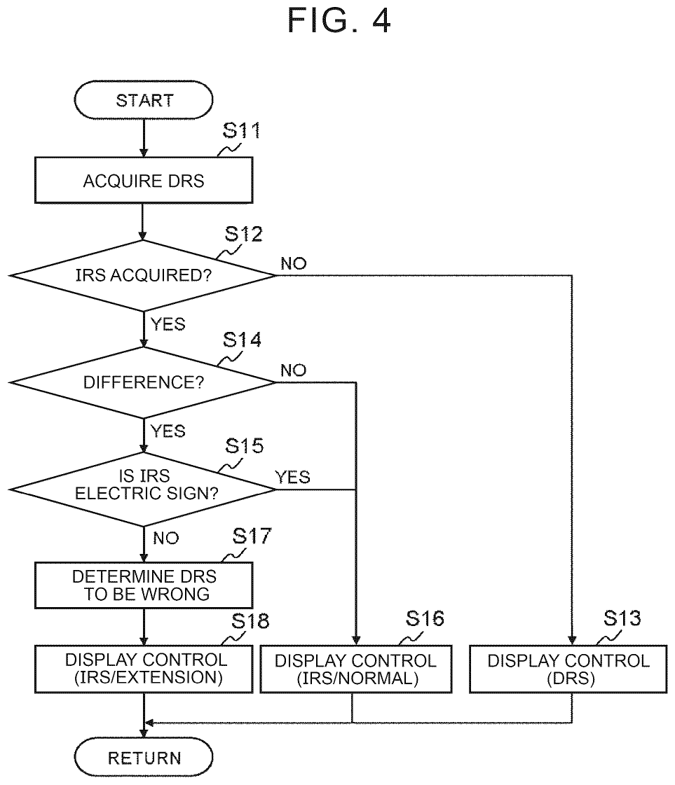

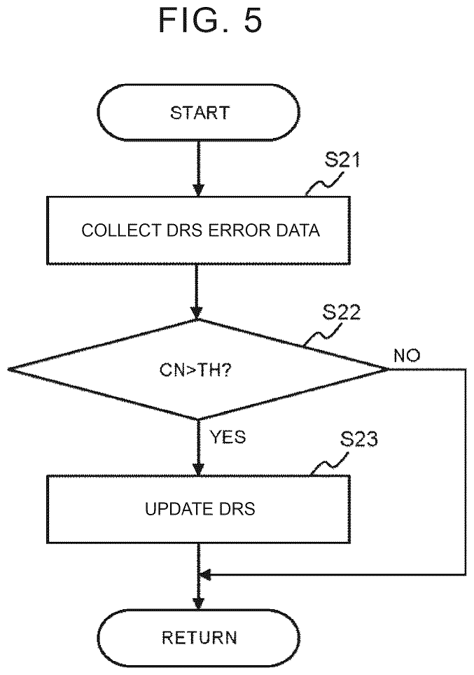

FIG. 4 and FIG. 5 are flowcharts illustrating an example of a process particularly related to an embodiment. The flowcharts shown in FIGS. 4 and 5 are repeatedly executed by the processor 31 shown in FIG. 1 at a predetermined control cycle.

In the routine illustrated in FIG. 4, first, the travel road sign DRS is acquired (S11). The travel road sign DRS is acquired based on the position information POS and the map information MAP. For example, the present position of the vehicle 1 and the travel road DR are identified from the history of the position information POS. Subsequently, the travel road sign DRS is acquired by referring to the present position and the map information MAP using the travel road DR.

Following S11 process, it is determined whether or not the image-recognized sign IRS has been acquired (S12). The image-recognized sign IRS is acquired when the traffic sign RS is recognized from the image information IMG. That is, when the traffic sign RS is not recognized, the image-recognized sign IRS is not acquired.

When the determination result of S12 is negative, the display control based on the travel road sign DRS is performed (S13). The negative determination of S12 means that only the travel road sign DRS is acquired. Therefore, when the display control is performed in S13, traffic rule TRR indicating the travel road sign DRS is displayed on the display device 4.

If the determination of S12 is affirmative, it is determined whether there is a difference between the image-recognized sign IRS and the travel road sign DRS (S14). For example, if the similarity between the image-recognized sign IRS and the travel road sign DRS is less than the thresholds, it is determined that there is a difference between these indicators. If S14 determination is positive, it is determined whether or not the image-recognized sign IRS is an electro-optical marker (S15).

If the determination result of S14 is negative, or if the determination result of S15 is positive, the display control based on the image-recognized sign IRS is performed (S16). The negative determination of S14 means that there is no difference between the image-recognized sign IRS and the travel road sign DRS. Therefore, when the display control is performed in S16, the traffic rule TRR indicating the image-recognized sign IRS is displayed on the display device 4. The positive determination of S15 means that the image-recognized sign IRS is an electro-optical sign. Therefore, when the display control is performed in S16, the traffic rule TRR indicating the electric light sign is displayed on the display device 4. In this S16 of display control, a normal value α is used for the distance/time during which the traffic rule TRR indicated by the image-recognized sign IRS is continuously displayed.

If the determination of S15 is negative, it is determined that there is an error in the travel road sign DRS (S17). Then, the display control based on the image-recognized sign IRS is performed (S18). In this S18 of display control, an extension value β (>α) is used for the distance or time for which the traffic rule TRR indicated by the image-recognized sign IRS continues to be displayed.

In the routine shown in FIG. 5, first, error detection information of the travel road sign DRS is collected (S21). The error detection information is identified by, for example, the presence or absence of an error detection signal generated when it is determined that there is an error in the travel road sign DRS.

Following S21 process, it is determined whether the cumulative number CN of this determination exceeds a threshold TH (e.g., TH≥2) for the same travel road sign DRS determined to be erroneous (S22). When the traffic sign RS corresponds to an electro-optical sign, an error-detection-signal is not generated. If the traffic sign RS is incorrectly recognized, an error detection-signal may not be generated. However, the fact that the cumulative number CN exceeds the threshold TH means that there is a high possibility that there is an error in the travel road sign DRS even when the error detecting signal is not generated.

Therefore, when the determination result of S22 is affirmative, the travel road sign DRS is updated (S23). When the travel road sign DRS is updated, the travel road sign DRS included in the map information MAP is rewritten. The rewriting of the travel road sign DRS is performed, for example, by using the traffic rule TRR indicated by the image-recognized sign IRS compared with the travel road sign DRS.

In S23 process, the map information MAP regarding the information of the road provided with the travel road sign DRS may be updated instead of updating the travel road sign DRS. In this case, for example, the information processing device 3 communicates with the external servers to inquire about the presence or absence of the latest information regarding the road on which the travel road sign DRS is provided. If there is the latest information, the latest map information MAP is acquired from the map DB of the external servers, and the map information MAP stored in the map DB 5 is rewritten using the latest map information MAP.

When the map DB 5 is provided in the vehicle 1 and the information processing device 3 is not capable of communicating with the external server, the processing of displaying information prompting the user US to rewrite the travel road sign DRS (or rewrite the information of the road where the travel road sign DRS is provided) in S23 processing on the display device 4 can also be performed. As the information for urging the rewriting, guidance information of the rewriting service by the dealer of the vehicle 1 is exemplified.

What is claimed is:

1. An information notification device that notifies a user of a vehicle of a traffic rule for a travel road of the vehicle, the information notification device comprising:
a camera mounted on the vehicle and configured to acquire image information around the travel road;
a storage device storing map information including traffic signs installed on roads; and
a processor configured to output the traffic rule to a display device, wherein
the processor is configured to
when no traffic sign is recognized from the image information, generate the traffic rule based on a travel road sign that indicates the traffic sign included in the map information and installed on the travel road, and
when any traffic sign is recognized from the image information, generate the traffic rule based on an image-recognized sign that indicates the traffic sign recognized from the image information, and
the processor is further configured to
when any traffic sign is recognized from the image information, determine based on the image-recognized sign whether the travel road sign is correct,
set a distance or time for which the traffic rule generated based on the image-recognized sign continues to be output to the display device, and
when the travel road sign is determined to be wrong, extend the distance or time for which the traffic rule continues to be output to the display device as compared to when the travel road sign is determined to be correct.

2. The information notification device according to claim 1, wherein the processor is further configured to
determine whether the image-recognized sign is a temporary traffic regulation sign, and
when the image-recognized sign is determined to be the temporary traffic regulation sign, not determine based on the image-recognized sign whether the travel road sign is correct.

3. The information notification device according to claim 1, wherein the processor is further configured to, when determination that the travel road sign is wrong is made at least twice for a same travel road sign, update the same travel road sign stored in the storage device, based on the image-recognized sign used to determine whether the same travel road sign is correct.

4. The information notification device according to claim 1, wherein:
the vehicle is configured to communicate with an external storage device provided outside the vehicle and storing map information including traffic signs installed on roads; and
the processor is further configured to
when determination that the travel road sign is wrong is made at least twice for a same travel road sign, acquire from the external storage device latest map information including traffic signs installed on a road on which the same travel road sign is installed, and
update the map information stored in the storage device with the latest map information.

5. The information notification device according to claim 1, wherein the processor is further configured to, when determination that the travel road sign is wrong is made at least twice for a same travel road sign, output information prompting to update the same travel road sign to the display device.
